(19) United States
(12) Patent Application Publication
(10) Pub. No.: US 2022/0360035 A1
(43) Pub. Date: Nov. 10, 2022

(54) TYPE C FEMALE SIDE CONNECTOR

(71) Applicant: AMPHENOL EAST ASIA ELECTRONIC TECHNOLOGY (SHEN ZHEN) CO., LTD., SHEN ZHEN, (CN)

(72) Inventor: KANG-QIN LI, SHEN ZHEN (CN)

(21) Appl. No.: 17/308,489

(22) Filed: May 5, 2021

(51) Int. Cl. H01R 43/18; H01R 13/506; H01R 24/60

(52) U.S. Cl. CPC H01R 43/18; H01R 13/506; H01R 24/60

(57) ABSTRACT

A Type C female side connector includes a terminal part, a body part, a steel plate, and a casing part; the terminal part is inserted in the body part; the body part is inserted in the casing part; the steel plate is inserted in the body part; the casing part has a suction portion formed in a flat plate structure on another side corresponding to an opening; the suction portion is integrated with the casing part; two sides of the suction portion expand to be sucked by a suck disc during manufacturing process. The present invention applies the suck disc portion to fulfill a sufficient area for automatic suction effect during manufacturing process, and includes a triple fix effect to strengthen the stability of the body part and the casing part.

### BACKGROUND OF THE INVENTION

### 1. Field of the Invention

The present invention relates to Type C connectors, and more particularly, to a novel Type C female side connector.

### 2. Description of the Related Art

With continuously growing data storage amount, the requirement on the transmission rate becomes higher, which represents, in the field of server storage, the increase of clock frequent and the rapid decrease of the rising time. Such change imposes higher demand for the manufacture of connectors. Due to a circular shape on two sides of the casing of female side connectors, current Type C side connectors have a relatively small area for a suction of a suck disc, causing the SMT suck disc to be incapable of sucking the product, such that the operation performance of collaborating technical equipment remains slow and fails to fulfill the higher requirement of a new generation of Type C connectors.

### SUMMARY OF THE INVENTION

To improve the issues above, the present invention discloses a Type C female side connector comprising a suction portion, which is different from conventional connectors.

For achieving the aforementioned objectives, a novel Type C female side connector is provided, comprising a terminal part, a body part, a steel plate, and a casing part; the terminal part is inserted in the body part, and comprises a dual-row pins structure arranged in a “7” shape; wherein the body part is inserted in the casing part; wherein the steel plate is inserted in the body part; one side of the casing part comprises an opening, through which the pins of the terminal part protrude out; the opening comprises a “7” shaped fix foot on two sides thereof; the casing part comprises a suction portion formed in a flat plate structure on another side corresponding to the opening; a middle portion of the suction portion is integrated with the casing part; two sides of the suction portion expand to form a flat structure, which is to be sucked by a suck disc during manufacturing process; one end of the terminal part is inserted in the body part, with another end of the terminal part protruding out from the opening of the casing part.

Preferably, the body part is formed of a plastic material and comprises a protrusion member and a body casing; the protrusion member is integrated with one end of the body casing; one side of the body casing connected with the protrusion member comprises a recess; the body casing has a groove on one side thereof.

Preferably, the casing part comprises an inward engagement protrusion corresponding to the recess; the casing part comprises a first inward engagement tongue matching the groove; the casing part comprises a second inward engagement tongue abutting against the protrusion member; therefore, a triple fix mechanism is achieved for stably fixing the body part in the casing part.

Preferably, the suction part comprises a fix portion and an expansion portion; the expansion portion is formed on two sides of the fix portion; the fix portion is integrated with the casing part; the expansion portion is formed of a portion of the casing part which is cut and expanded flatly.

Preferably, an outer side of the suction portion is a smooth face.

With such configuration, the present invention achieves following advantages.

Compared with conventional arts, the novel Type C female side connector is added with a suction portion, which is stamped to form an area fulfilling the suction demand for the suck disc, achieving an automatic suction effect. The present invention is provided with a triple fix mechanism, thereby strengthening the stability of the body part and the casing part, and resolving the insufficient operation performance during manufacturing process of a Type C female side connector.

### BRIEF DESCRIPTION OF THE DRAWINGS

FIG. 1 is an exploded view of the Type C female side connector in accordance with an embodiment of the present invention.

FIG. 2 is a perspective view of the Type C female side connector in accordance with an embodiment of the present invention.

FIG. 3 is another perspective view of the Type C female side connector in accordance with an embodiment of the present invention.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion.

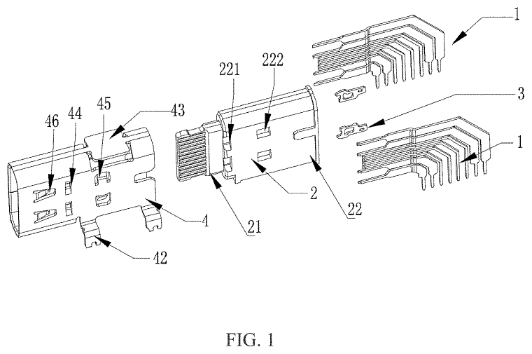

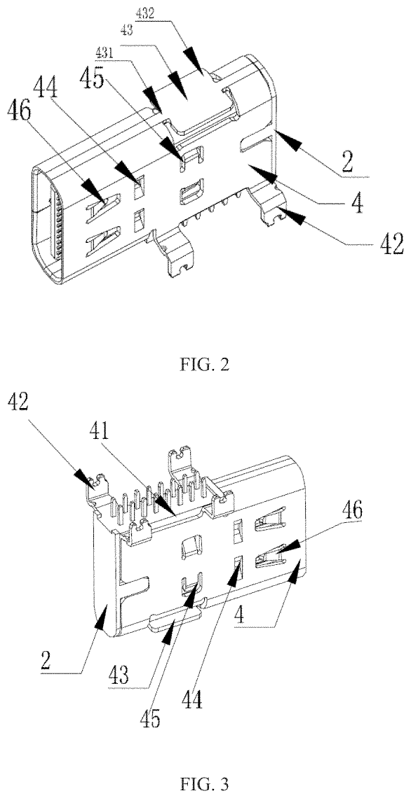

Referring to FIG. 1 to FIG. 3, the present invention is described in detail with a specific embodiment. However, such embodiment does not limit the present invention.

### Embodiment 1

Referring to FIG. 1 to FIG. 3, a novel Type C female side connector comprises a terminal part 1, a body part 2, a steel plate 3, and a casing part 4; the terminal part 1 is inserted in the body part 2, and comprises a dual-row pins structure arranged in a “7” shape; wherein the body part 2 is inserted in the casing part 4; wherein the steel plate 3 is inserted in the body part 2;

one side of the casing part 4 comprises an opening 41, through which the pins of the terminal part 1 protrude out; the opening 41 comprises a “7” shaped fix foot 42 on two sides thereof;

the casing part 4 comprises a suction portion 43 formed in a flat plate structure on another side corresponding to the opening 41; a middle portion of the suction portion 43 is integrated with the casing part 4; two sides of the suction portion 43 expand to form a flat structure, which is to be sucked by a suck disc during manufacturing; one end of the terminal part 1 is inserted in the body part 2, with another end of the terminal part protruding out from the opening of the casing part 4.

Referring to FIG. 1 to FIG. 3, preferably, the body part 2 is formed of a plastic material and comprises a protrusion member and a body casing 22; the protrusion member 21 is integrated with one end of the body casing 22; one side of the body casing 21 connected with the protrusion member 21 comprises a recess 221; the body casing 22 has a groove 222 on one side thereof. The casing part 4 comprises an inward engagement protrusion 44 corresponding to the recess 221; the casing part 4 comprises a first inward engagement tongue 45 matching the groove 222; the casing part 4 comprises a second inward engagement 46 tongue abutting against the protrusion member 21; therefore, a triple fix mechanism is achieved for stably fixing the body part 2 in the casing part 4. The suction part 43 comprises a fix portion 431 and an expansion portion 432; the expansion portion 432 is formed on two sides of the fix portion 431; the fix portion 431 is integrated with the casing part 4; the expansion portion 432 is formed of a portion of the casing part 4 which is cut and expanded flatly. An outer side of the suction portion 43 is a smooth face.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A Type C female side connector, comprising a terminal part, a body part, a steel plate, and a casing part;
the terminal part is inserted in the body part, and comprises a dual-row pins structure arranged in a “7” shape; wherein the body part is inserted in the casing part; wherein the steel plate is inserted in the body part;
one side of the casing part comprises an opening, through which the pins of the terminal part protrude out; the opening comprises a “7” shaped fix foot on two sides thereof;
the casing part comprises a suction portion formed in a flat plate structure on another side corresponding to the opening; a middle portion of the suction portion is integrated with the casing part; two sides of the suction portion expand to form a flat structure, which is to be sucked by a suck disc during manufacturing process.

2. The Type C female side connector of claim 1, wherein one end of the terminal part is inserted in the body part, with another end of the terminal part protruding out from the opening of the casing part.

3. The Type C female side connector of claim 1, wherein the body part is formed of a plastic material and comprises a protrusion member and a body casing; the protrusion member is integrated with one end of the body casing; one side of the body casing connected with the protrusion member comprises a recess; the body casing has a groove on one side thereof.

4. The Type C female side connector of claim 1, wherein the casing part comprises an inward engagement protrusion corresponding to the recess; the casing part comprises a first inward engagement tongue matching the groove; the casing part comprises a second inward engagement tongue abutting against the protrusion member, such that the body part is stably fixed in the casing part.

5. The Type C female side connector of claim 1, wherein the suction part comprises a fix portion and an expansion portion; the expansion portion is formed on two sides of the fix portion; the fix portion is integrated with the casing part; the expansion portion is formed of a portion of the casing part which is cut and expanded flatly.

6. The Type C female side connector of claim 1, wherein an outer side of the suction portion is a smooth face.

7. The Type C female side connector of claim 3, wherein the casing part comprises an inward engagement protrusion corresponding to the recess; the casing part comprises a first inward engagement tongue matching the groove; the casing part comprises a second inward engagement tongue abutting against the protrusion member, such that the body part is stably fixed in the casing part.
